(19) United States
(12) Patent Application Publication
(10) Pub. No.: US 2026/0218014 A1
(43) Pub. Date: Jul. 30, 2026

(54) SELF-ADHERING INSULATION OR COVER BOARD

(71) Applicant: SIKA TECHNOLOGY AG, Baar (CH)

(72) Inventors: Michael DARSCH, Canton, MA (US); Albert J. Duhamel, Canton, MA (US); Kristen Glasheen, Canton, MA (US); Laurie Hill, Lewisville, TX (US); Blaise W. Leeber, Canton, MA (US); Ajay Padwal, Canton, MA (US)

(73) Assignee: SIKA TECHNOLOGY AG, Baar (CH)

(21) Appl. No.: 19/037,616

(22) Filed: Jan. 27, 2025

(51) Int. Cl. C09J 7/38; C09J 7/21; C09J 7/25

(52) U.S. Cl. CPC C09J 7/38; C09J 7/21; C09J 7/25; C09J 2203/346; C09J 2301/302; C09J 2301/304; C09J 2400/22

(57) ABSTRACT

An insulation or cover board includes a substrate layer having upper and lower primary exterior surfaces and an adhesive layer covering at least a portion of one of the primary exterior surfaces of the substrate layer, wherein the adhesive layer is formed of a non-reactive hot-melt pressure sensitive adhesive.

### TECHNICAL FIELD

The invention relates to the field of insulated structures comprising insulation and/or cover boards. Particularly, the invention relates to self-adhering insulation and cover boards having a non-reactive hot-melt adhesive coated one or both sides of the board.

### BACKGROUND OF THE INVENTION

Building envelope is the physical separator between the conditioned and unconditioned environment of a building, including the resistance to air, water, heat, light, and noise transfer. Components of a building envelope can be divided into three categories based on their functions including support, control, and finish functions. One of the most important functions of a building envelope is to protect the structures from water. Different types of barriers, drained screens, and storage systems are present in the building envelope to serve for this purpose.

For example, the main purpose of a roof is to protect the inside of a building structure from water, particularly rain water. A flat roof system typically contains a roof deck and a roof covering, also known as a roofing membrane, whereas pitched roof include a roof underlayment and roof shingles as the roof coverage. Commonly used materials for the roofing membranes include plastics, in particular thermoplastics such as plasticized polyvinylchloride (p-PVC), thermoplastic olefins (TPE-O, TPO), and elastomers such as ethylene-propylene diene monomer (EPDM). The roofing membranes are typically delivered to a construction site in form of rolls, transferred to the place of installation, unrolled, and adhered to the substrate to be waterproofed.

Walls are less exposed to rain water compared to roofs but they still play a crucial role in controlling of the movement of water as part of the building envelope. Barrier walls such as concrete and masonry wall have been designed to allow water to be absorbed but not to penetrate the wall. On the other hand, sealed-surface walls do not allow any water penetration at their exterior surface. Since commonly used wall materials are typically not waterproof, wall underlayment and/or coverings, also known as house wrappings, are used to ensure long term waterproofing properties of sealed-surface walls.

Building structure typically also contain a thermal envelope, which is used to control the flow of heat energy between the inside and outside of the building. A thermal envelope can be a part of the building envelope, such as part of a roof assembly, or located elsewhere, for example in a ceiling.

A flat roof system can contain a rigid insulation board, such as an EPS, XPS, or PIR board installed between the roof deck and the roof cover to improve the thermal insulation properties of the roof assembly. The roofing membrane can be applied directly on the top of the insulation board or alternatively the roofing membrane can be secured to a cover board, which is applied on top of the insulation board. In ventilated and cold roof designs, the insulation board can also be located below the roof deck.

Insulation boards are also used to improve thermal insulation properties of wall structures. For example, an insulation board can be installed between a masonry block wall and a brick veneer as a cavity insulation element or applied to the interior face of concrete or concrete masonry wall to provide a layer of continuous insulation over the entire surface of the wall. Further uses of insulation boards include surfaces of block walls, standard cavity walls, and the underside of slabs such as ceilings of parking structures.

Insulation boards are typically adhered to roof decks or other substrates by using mechanical or adhesive bonding means. In roofing, the fastening means used for securing the roofing membrane to the insulation board may also be used for securing the insulation board to the roof deck. In practice the whole roof assembly including the roofing membrane, insulation board and cover board, if used, is attached to the roof deck by using screws that penetrate through the whole assembly into the roof deck. Alternatively, the insulation board can be secured to the roof deck by using adhesives, typically by contact bonding or by using two-component polyurethane adhesives. In contact bonding, the insulation board and the surface of the roof deck are first coated with a water- or solvent-based contact adhesive. The volatile components of the adhesive are “flashed off” to provide partially dried adhesive films, which are then contacted with each other to effect adhesive bonding between the insulation board and the surface of the roof deck.

The main disadvantage of solvent-based adhesives relates to the environmental concerns. All stages of the manufacturing and application process for solvent-based adhesives release volatile organic compounds (VOCs) into the atmosphere. Water-based adhesives may be preferred in terms of environmental aspects, but their use is practically restricted to temperatures of 5° C. and above. Generally, the contact bonding also complicates the installation process since drying of the wet adhesive layers requires considerable amount of time. On the other hand, two-component polyurethane adhesives are also used in bead application, and require specialized application equipment, safety measures regarding EHS, and careful control of the curing time, which is especially demanding during hot or cold days. Consequently, majority of the roofs systems are either mechanically fastened or ballasted roofs.

There thus remains a need for a novel type of insulation or cover board, which enables thermal insulation of roof and wall structures using a simplified and cost-effective installation method.

### SUMMARY OF THE INVENTION

The object of the present invention is to provide an insulation or cover board, which enables thermal insulation of roof and wall structures using a simplified and cost-effective installation method.

The subject of the present invention is insulation or cover board as defined in claim 1.

It was surprisingly found out that non-reactive hot-melt adhesives can be used for providing self-adhering insulation and cover boards with reduced production costs.

One of the advantages of the insulation and roofing boards of the present invention is that they can be produced using common coating techniques without additional treatment steps, for example, to dry wet adhesive layers or to improve the thermal or chemical stability of the applied adhesive layers, such as by curing with UV-radiation. On the other hand, the use of the insulation and cover boards comprising a pre-applied adhesive layer enables providing roof systems using a simplified installation process.

Other aspects of the present invention are presented in other independent claims. Preferred aspects of the invention are presented in the dependent claims.

### BRIEF DESCRIPTION OF THE DRAWINGS

FIG. 1 shows a cross-section of an insulation or cover board (1, 1′) comprising a substrate layer (2), an adhesive layer (3) covering the lower primary exterior surface of the substrate layer (2), and a release liner (4) covering the outer major surface of the adhesive layer (3).

FIG. 2 shows a cross-section of an insulation or cover board (1, 1′) comprising a substrate layer (2), a first adhesive layer (3′) covering the lower primary exterior surface of the substrate layer (2), a first release liner (4) covering the outer major surface of the first adhesive layer (3′), a second adhesive layer (3″) covering the upper primary exterior surface of the substrate layer (2), and a second release liner (4′) covering the outer major surface of the second adhesive layer (3″).

FIG. 3 shows a perspective view of an insulation or cover board (1, 1′), wherein the adhesive layer (3) is composed of adhesive elements in form of spaced-apart adhesive stripes extending in the longitudinal direction (L) of the board (1, 1′).

FIG. 4 shows a cross-section of an insulated structure (5) comprising a roof deck (6), an insulation board (1), and a roofing membrane (7) covering the upper major surface of the insulation board (1), wherein the roofing membrane (7) is bonded to the upper major surface of the insulation board (1) via a second adhesive layer (3″) and the insulation board (1) is bonded to a surface of the roof deck (6) via a first adhesive layer (3′).

### DETAILED DESCRIPTION OF THE INVENTION

The subject of the present invention is an insulation or cover board (1, 1′) comprising:
i. a substrate layer (2) having upper and lower primary exterior surfaces,
ii. an adhesive layer (3) covering at least a portion of one of the primary exterior surfaces of the substrate layer (2), and
iii. optionally a release liner (4),
wherein the adhesive layer (3) is formed of a non-reactive hot-melt pressure sensitive adhesive.

The term “hot-melt adhesive” designates solvent free adhesives, which are solid at room temperature and which are applied to a substrate in form of a melt.

The term “pressure sensitive adhesive” refers in the present disclosure to viscoelastic materials, which adhere immediately to almost any kind of substrates by application of light pressure and which are permanently tacky. Tackiness of an adhesive layer can be measured, for example, as a loop tack. Particularly, the adhesive layer may have a loop tack adhesion to a glass plate measured at a temperature of 23° C. of at least 2.5 N/25 mm, preferably at least 5 N/25 mm, more preferably at least 10 N/25 mm. The loop tack adhesion can be measured using a “FINAT test method no. 9 (FTM 9) as defined in FINAT Technical Handbook, 9th edition, published in 2014.

The term “non-reactive hot-melt adhesive” designates adhesives, which are applied to a substrate in form of a melt and which after cooling solidify and form an adhesive bond with the substrate through physically occurring bonding. Particularly, the non-reactive hot-melt adhesives do not react chemically to cure.

The insulation or cover board of the present invention comprises a substrate layer and an adhesive layer covering at least a portion of one of the primary exterior surfaces of the substrate layer. The term “primary exterior surface of the substrate layer” refers in the present disclosure to the outermost surfaces, i.e., the upper and lower surfaces of the substrate layer, defining a thickness of the substrate layer therebetween.

The insulation or cover board is preferably a self-adhering insulation or cover board. The term “self-adhering” is understood to mean that the insulation or cover board comprising the adhesive layer is provided as a pre-formed article that has been formed before being installed to a surface of a substrate a building structure. Such pre-formed articles are fabricated at a location that is typically remote from the construction site, transported to the place of installation, and placed on a surface of a substrate to form a part of an insulated structure, for example, a flat roof assembly, a ceiling, a wall, or a basement structure.

In embodiments, the adhesive layer has a softening point measured with Ring & Ball method according to ISO 4625-1:2020 standard of 85-165° C., preferably 105-145° C. and/or a melting point determined by differential scanning calorimetry (DSC) according to ISO 11357-3 standard using a heating rate of 2° C./min of 95-175° C., preferably 115-155° C.

In embodiments, the adhesive layer comprises at least one polymer P selected from styrene block copolymers, acrylic polymers, amorphous polyolefins (APO), vinyl ether polymers, ethylene vinyl acetate copolymers, and rubbers.

Particularly, the adhesive layer may comprise 15-75 wt.-%, preferably 25-65 wt.-%, more preferably 35-55 wt.-%, of the at least one polymer P.

Suitable rubbers for use in the adhesive layer include, for example, styrene-butadiene rubber (SBR), ethylene propylene diene rubber (EPDM), butyl rubber (IIR), polyisoprene, polybutadiene, natural rubber, polychloroprene rubber, ethylene-propylene rubber (EPR), nitrile rubber, and silicone rubber.

In addition to the at least one polymer P, the adhesive layer may comprise one or more additional constituents including, for example, tackifying resins, plasticizers, waxes, and additives, such as UV- and heat stabilizers, UV-absorbers, optical brighteners, pigments, dyes, and desiccants.

In embodiments, the at least one polymer P is a styrene block copolymer.

The expression “the at least one polymer P is a styrene block copolymer” is understood to mean that the at least one polymer P is selected from a group consisting of styrene block copolymers.

Suitable styrene block copolymers for use as the at least one polymer P include block copolymers of the SX and SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), completely or partially hydrogenated polybutadiene (poly ethylene-butylene). The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks.

In embodiments, the at least one polymer P is selected from styrene-isoprene diblock (SI) copolymers, styrene-isoprene-styrene triblock (SIS) copolymers, styrene-butadiene diblock (SB) copolymers, styrene-butadiene-styrene triblock (SBS) copolymers, styrene-isoprene-butadiene-styrene block copolymers (SIBS), styrene-ethylene-butadiene-styrene (SEBS) block copolymers, styrene-ethylene-propylene-styrene block (SEPS) copolymers, and styrene-ethylene-ethylene-butylene-styrene copolymers (SEEPS).

Particularly suitable styrene block copolymers for use as the at least one polymer P include, for example, block copolymers containing polystyrene and polybutadiene blocks and/or polyisoprene blocks. These materials are generally available as pure triblock copolymers, also known as SIS and SBS block copolymers, and as diblock copolymers (SI and SB block copolymers). Furthermore, these types of styrene block copolymers are also commercially available as mixtures of diblock and triblock copolymers. Suitable styrene block copolymers can have a linear, radial, or star structure, wherein the linear structure may be preferred.

In embodiments, the at least one polymer P is selected from styrene-isoprene diblock (SI) copolymers, styrene-isoprene-styrene triblock (SIS) copolymers, styrene-butadiene diblock (SB) copolymers, and styrene-butadiene-styrene triblock (SBS) copolymers.

Suitable SI, SIS, SB, and SBS block copolymers are commercially available, for example from TSRC/Dexco under the trade name of Vector®, such as Vector® 4000-series, and from Kraton Polymers under the trade name of Kraton® D-series.

In embodiments, the at least one polymer P is an acrylic polymer.

The term “acrylic polymer” designates in the present disclosure homopolymers, copolymers and higher inter-polymers of an acrylic monomer with one or more further acrylic monomers and/or with one or more other ethylenically unsaturated monomers.

The term “acrylic monomer” refers in the present disclosure to monomers having at least one (meth)acryloyl group in the molecule. The term “(meth)acryloyl” designates methacryloyl or acryloyl. Accordingly, the term “(meth)acrylic” designates methacrylic or acrylic. A (meth)acryloyl group is also known as (meth)acryl group.

Examples of suitable acrylic monomers for the acrylic polymer include, for example, (meth)acrylates, (meth)acrylic acid or derivatives thereof, for example, amides of (meth)acrylic acid or nitriles of (meth)acrylic acid, and (meth)acrylates with functional groups such as hydroxyl group-containing (meth)acrylates and alkyl (meth)acrylates.

In embodiments, the acrylic polymer AP has been obtained from a monomer mixture comprising at least 45 wt.-%, preferably at least 55 wt.-%, more preferably at least 65 wt.-%, even more preferably at least 75 wt.-%, still more preferably at least 85 wt.-%, based on the total weight of the monomer mixture, of at least one acrylic monomer AM of formula (I):

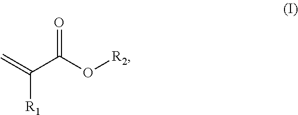

where
R₁ represents a hydrogen or a methyl group; and
R₂ represents a branched, unbranched, cyclic, acyclic, or saturated alkyl group having from 2 to 30 carbon atoms.

Examples of suitable acrylic monomers of formula (I) include methyl acrylate, methyl methacrylate, ethyl acrylate, ethoxy ethoxy ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, as for example isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Suitable comonomers to be used with the acrylic monomers of formula (I) include, for example, hydroxyl group containing acrylic monomers, such as 2-hydroxyethyl(meth)acrylate, 2-hydroxypropyl(meth)acrylate, 3-hydroxypropyl(meth)acrylate, 2-hydroxybutyl(meth)acrylate, 4-hydroxybutyl butyl(meth)acrylate, 2-hydroxy-hexyl(meth)acrylate, 6-hydroxy hexyl(meth) acrylate, 8-hydroxyoctyl(meth)acrylate, 10-hydroxydecyl(meth)acrylate, 12-hydroxylauryl (meth)acrylate. Further suitable hydroxyl group containing acrylic monomers include (4-hydroxymethyl cyclohexyl)methyl acrylate, polypropylene glycol mono (meth)acrylate, N-hydroxyethyl (meth)acrylamide, and N-hydroxypropyl (meth)acrylamide, esters of hydroxyethyl (meth)acrylate and phosphoric acid, and trimethoxysilylpropyl methacrylate.

In embodiments, the monomer mixture used for obtaining the acrylic polymer comprises not more than 25 wt.-%, preferably not more than 20 wt.-%, such as 0.01-15 wt.-%, preferably 0.1-10 wt.-%, based on the total weight of the monomer mixture, of at least one hydroxyl group containing acrylic monomer.

Further suitable comonomers for the synthesis of the acrylic polymer include vinyl compounds, such as ethylenically unsaturated hydrocarbons with functional groups, vinyl esters, vinyl halides, vinylidene halides, nitriles of ethylenically unsaturated hydrocarbons, phosphoric acid esters, and zinc salts of (meth)acrylic acid. Examples of especially suitable vinyl compounds include, for example, maleic anhydride, styrene, styrenic compounds, acrylic acid, beta-acryloyloxypropionic acid, vinylacetic acid, fumaric acid, crotonic acid, aconitic acid, trichloroacrylic acid, itaconic acid, vinyl acetate, and acryloyl morpholine.

In embodiments, the monomer mixture used for obtaining the acrylic polymer comprises at least 0.1 wt.-%, preferably at least 0.5 wt.-%, such as 0.1-20 wt.-%, preferably 0.5-15 wt. %, based on the total weight of the monomer mixture, of at least one vinyl compound, preferably selected from the group consisting of maleic anhydride, styrene, styrenic compounds, (meth)acrylamides, N-substituted (meth)acrylamides, acrylic acid, beta-acryloyloxypropionic acid, vinylacetic acid, fumaric acid, crotonic acid, aconitic acid, dimethylacrylic acid, trichloroacrylic acid, itaconic acid, vinyl acetate, and amino group-containing (meth)acrylates.

In embodiments, the adhesive layer further comprises, in addition to the at least one polymer P:
c) At least one tackifying resin TR and
d) Optionally at least one plasticizer PL.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C.

Examples of suitable tackifying resins to be used as the at least one tackifying resin TR include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins.

Monomers that may be polymerized to synthesize the synthetic resins may include aliphatic monomer, cycloaliphatic monomer, aromatic monomer, or mixtures thereof. Aliphatic monomers can include C₄, C₅, and C₆ paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mₙ), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C₅ aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RÜTGERS Novares GmbH); and under the trade name of Kristalex®, Plastolyn®, Piccotex®, Piccolastic® and Endex® (all from Eastman Chemicals).

In embodiments, the at least one tackifying resin TR has:
a softening point measured with Ring & Ball method according to ISO 4625-1:2020 standard in the range of 65-185° C., preferably 75-175° C., more preferably 80-170° C. and/or
a number average molecular weight (Mₙ) in the range of 150-5000 g/mol, preferably 250-3500 g/mol, more preferably 250-2500 g/mol and/or
a glass transition temperature (T_{g}) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 25° C.

The term “molecular weight” designates the molar mass (g/mol) of a molecule or a part of a molecule, also referred to as “moiety”. The term “average molecular weight” refers to weight average (M_{w}) or number average (Mₙ) molecular weight of an oligomeric or polymeric mixture of molecules or moieties. The molecular weight may be determined by conventional methods, preferably by gel permeation-chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

Particularly, the adhesive layer may comprise at least 5 wt.-%, particularly at least 10 wt.-% of the at least one tackifying resin TR.

In embodiments, the adhesive layer contains 10-60 wt.-%, preferably 15-55 wt.-%, more preferably 20-50 wt.-% of the at least one tackifying resin TR.

Suitable plasticizers for use as the at least one plasticizer PL include, for example, process oils and liquid polyolefin resins.

Especially suitable process oils include mineral oils, synthetic oils, and vegetable oils.

The term “mineral oil” refers in the present disclosure hydrocarbon liquids of lubricating viscosity (i.e., a kinematic viscosity at 100° C. of 1 cSt or more) derived from petroleum crude oil and subjected to one or more refining and/or hydroprocessing steps, such as fractionation, hydrocracking, dewaxing, isomerization, and hydrofinishing, to purify and chemically modify the components to achieve a final set of properties. In other words, the term “mineral” refers in the present disclosure to refined mineral oils, which can be also characterized as Group I-III base oils according to the classification of the American Petroleum Institute (API).

Suitable mineral oils for use as the at least one plasticizer PL include paraffinic, naphthenic, and aromatic mineral oils. Particularly suitable mineral oils include paraffinic and naphtenic oils containing relatively low amounts of aromatic moieties, such as not more than 25 wt.-%, preferably not more than 15 wt.-%, based on the total weight of the mineral oil.

The term “synthetic oil” refers in the present disclosure to full synthetic (polyalphaolefin) oils, which are also known as Group IV base oils according to the classification of the American Petroleum Institute (API). Suitable synthetic oils are produced from liquid polyalphaolefins (PAOs) obtained by polymerizing α-olefins in the presence of a polymerization catalyst, such as a Friedel-Crafts catalyst. In general, liquid PAOs are high purity hydrocarbons with a paraffinic structure and high degree of side-chain branching. Particularly suitable synthetic oils include those obtained from so-called Gas-To-Liquids processes.

The term “liquid polyolefin resin” refers in the present disclosure to a polyolefin resin that flows at normal room temperature, i.e., has a pour point of less than 20° C.

Suitable liquid polyolefin resins to be used as the at least one plasticizer PL include, for example, liquid polybutene and liquid polyisobutylene (PIB). The term “liquid polybutene” refers in the present disclosure to low molecular weight olefin oligomers comprising isobutylene and/or 1-butene and/or 2-butene. The ratio of the C4-olefin isomers can vary by manufacturer and by grade. When the C4-olefin is exclusively 1-butene, the material is referred to as “poly-n-butene” or “PNB”. The term “liquid polyisobutylene” refers in the present document to low molecular weight olefin oligomers of isobutylene, preferably containing at least 75 wt.-%, more preferably at least 85 wt.-% of repeat units derived from isobutylene. Suitable liquid polybutenes and polyisobutylenes have a number average molecular weight (Mₙ) of less than 5000 g/mol, preferably less than 3500 g/mol, more preferably less than 3000 g/mol, even more preferably less than 2500 g/mol.

Suitable liquid polybutenes and polyisobutylenes are commercially available, for example, under the trade name of Indopol®, such as Indopol® H-300 and Indopol® H-1200 (from Ineos); under the trade name of Glissopal®, such as Glissopal® V230, Glissopal® V500, and Glissopal® V700 (from BASF); under the trade name of Dynapak®, such as Dynapak® poly 230 (from Univar GmbH, Germany); and under the trade name of Daelim®, such as Daelim® PB 950 (from Daelim Industrial).

Especially suitable liquid polybutenes and liquid polyisobutylenes for use as the at least one plasticizer PL have:
an average molecular weight (Mₙ) of 150-3500 g/mol, preferably 250-3000 g/mol and/or
a pour point determined according to ISO 3016 in the range of −10 to +15° C., preferably from −10 to +10° C. and/or
a polydispersity index (M_{w}/Mₙ), determined by GPC, of not more than 5, preferably in the range of 0.5-5.0, more preferably 1.0-4.5.

In embodiments, the adhesive layer comprises 0.5-15 wt.-%, preferably 1.5-12.5 wt.-%, more preferably 2.5-10 wt.-% of the at least one plasticizer PL.

It was surprisingly found out that the adhesive layer composed of the non-reactive hot-melt pressure sensitive adhesive can provide a sufficient bond strength to resist the shearing forces resulting from high wind loads even if the adhesive is not applied to cover the whole area of the corresponding primary exterior surface of the substrate layer.

In embodiments, the adhesive layer covers not more than 75%, preferably not more than 50%, more preferably nor more than 35%, even more preferably not more than 25% and/or at least 0.5%, preferably at least 1.0%, more preferably at least 1.5%, even more preferably at least 2.0% of the total area of the upper or lower primary exterior surface of the substrate layer.

In further embodiments, the adhesive layer covers 0.5-30%, preferably 1.0-25 wt.-%, more preferably 1.5-20%, even more preferably 2.0-15% of the total area of the upper or lower primary exterior surface of the substrate layer.

Particularly, the adhesive layer may have a coating weight of 50-1500 g/m², such as 150-1000 g/m², especially 200-750 g/m².

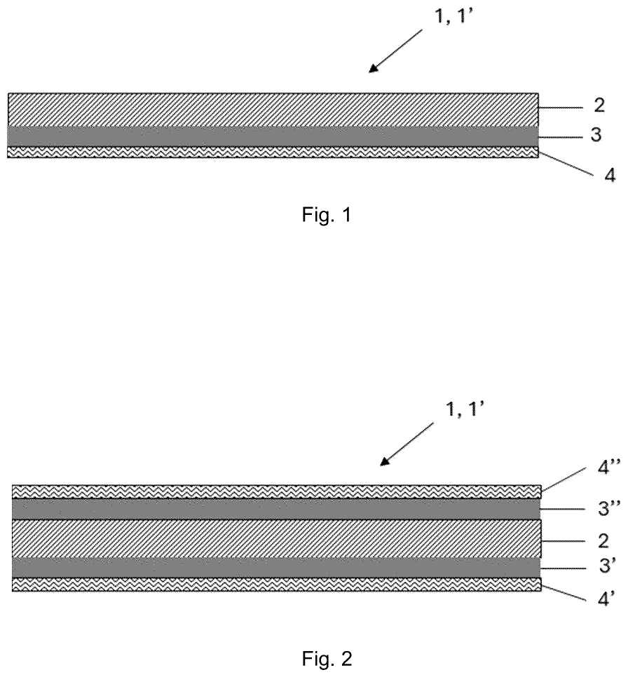

In embodiments, the insulation or cover board comprises one single adhesive layer, which may be arranged on the lower primary exterior surface, as shown in FIG. 1.

In further embodiments, the insulation or cover board comprises a first adhesive layer arranged on the lower primary exterior surface of the substrate layer and a second adhesive layer arranged on the upper primary exterior surface of the substrate layer, as shown in FIG. 2.

The preferences given above for the adhesive layer apply equally for the first and second adhesive layers.

The adhesive layer can be a in form of a continuous or discontinuous adhesive layer.

The term “continuous adhesive layer” is understood to mean that the adhesive layer is composed of a single adhesive element covering an area of a surface, particularly an area of one of the primary exterior surfaces of the substrate layer.

In contrast, the term “discontinuous adhesive layer” is understood to mean that the adhesive layer is composed of spaced-apart adhesive elements forming a discontinuous network of areas that are covered with the adhesive.

In embodiments, the adhesive layer is a discontinuous adhesive layer, preferably composed of a plurality of spaced-apart adhesive elements, particularly in form of adhesive stripes or dots.

In embodiments, the spaced-apart adhesive elements are in form of adhesive stripes, preferably extending in the longitudinal (L) or transverse (W) direction of the insulation or cover board, particularly parallel to each other, especially from one peripheral edge to opposite peripheral edge of the insulation or cover board.

Particularly, the individual adhesive stripes may have a with of at least 1.0 mm, especially at least 2.5 mm and/or not more than 150 mm, especially not more than 100 mm.

In embodiments, the adhesive stripes have a width of 1.0-20 mm, preferably 2.5-15 mm and/or the distance between two adjacent adhesive stripes is at least 15 mm, preferably at least 35 mm.

It is also possible that some adhesive stripes have a smaller or greater width than the other adhesive stripes. For example, longitudinally extending adhesive stripes that are closer to the longitudinal edges of the insulation or cover board may have a larger width than the adhesive stripes that are nearer the center of the board, or vice versa.

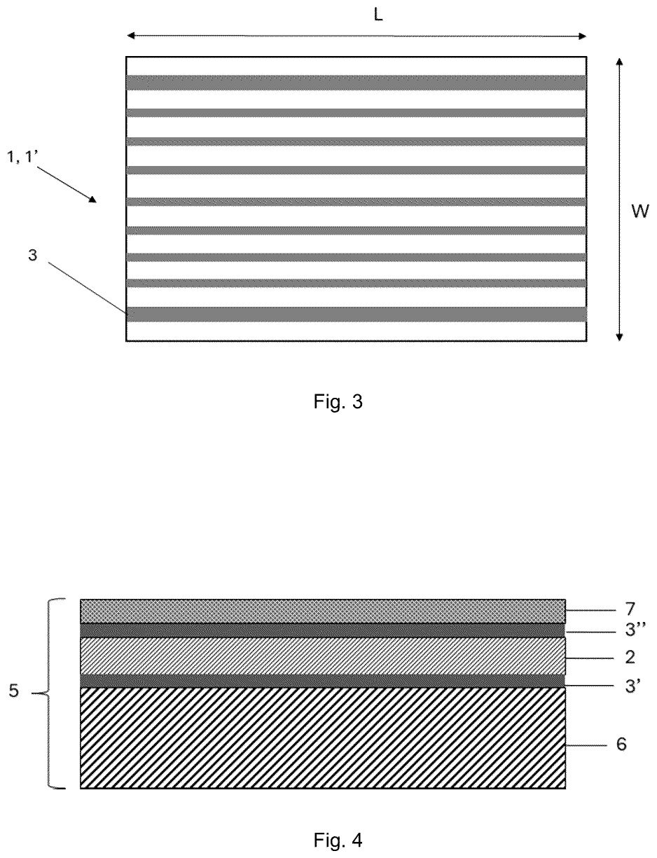

FIG. 3 shows a perspective view of an insulation or cover board (1, 1′) with an adhesive layer (3) composed of adhesive stripes extending in the longitudinal direction (L) of the board, wherein the outermost adhesive stripes that are closest to the longitudinal edges of the board have greater width than the adhesive stripes that the located between the two outermost adhesive stripes.

In embodiments, the adhesive stripes extend in longitudinal direction of the of the insulation or cover board, particularly wherein the outermost adhesive stripes that are closest to the longitudinal edges of the board have greater width, such as at least 2.5%, especially at least 5%, particularly at least 10% greater width than the adhesive stripes that the located between the two outermost adhesive stripes.

Furthermore, the adhesive layer may be composed of at least 2, especially at least 3, particularly at least 4 the adhesive stripes and/or of not more than 100, especially not mor than 75, particularly not more than 50 of the adhesive stripes.

The insulation or cover board may further comprises a release liner, which is typically used to prevent premature unwanted adhesion and to protect the adhesive layer from moisture, fouling, and other environmental factors. The release liner is preferably arranged to cover the outer major surface of the adhesive layer facing away from the substrate layer.

The release liner may be sliced into multiple sections to allow portioned detachment of the release liner from the adhesive layer. Furthermore, size of the planar area of the release liner, calculated as width times length of the release liner, may exceed the size of the respective planar area of the of the substrate layer.

Furthermore, the release liner may extend beyond the short and/or long edges of the substrate layer to form one or more short/long edge flaps. The width of such edge flap is preferably not more than 5 mm, more preferably 0.5-2.5 mm, even more preferably 1-2 mm.

In embodiments, the release liner is a polymeric film or a polymer-coated paper.

Suitable polymeric films for the release liner include, for example, polyethylene, polypropylene, and polyester films, optionally coated with polymeric release agents, such as silicone, silicone urea, urethanes, waxes, and long chain alkyl acrylate release agents. Suitable polymer-coated papers include at least Kraft paper, polyethylene coated paper, and silicone coated paper.

In embodiments, the insulation or cover board comprises a first release liner covering the outer major surface of a first adhesive layer facing away from the substrate layer and a second release liner covering the outer major surface of a second adhesive layer facing away from the substrate layer. The preferences given above for the release liner apply equally for the first and second release liners.

The substrate layer is preferably a sheet-like element having upper and lower primary exterior surfaces, i.e. top and bottom surfaces, defining a thickness of the layer therebetween.

The substrate layer may be a rectangular sheet having a length and width of at least 15 times, more preferably at least 25 times, even more preferably at least 50 times, greater than the thickness of the substrate layer.

In embodiments, the width and/or length of the substrate layer is at least 100 mm, preferably at least 250 mm, particularly at least 500 mm and/or not more than 7500 mm, preferably not more than 5000 mm, particularly not more than 3000 mm.

In embodiments, the substrate layer comprises a low-density panel, preferably a low-density foam panel having a closed cell structure. Such low-density foam panels are especially suitable for use in insulation boards.

Suitable low-density foam panels having a closed cell structure include, for example, molded expanded polystyrene (EPS) foam panels, extruded expanded polystyrene (XPS) foam panels, polyurethane foam panels (PUR), and polyisocyanurate (PIR) foam panels.

In embodiments, the low-density foam panel is a molded expanded polystyrene (EPS) foam panel, an extruded expanded polystyrene (XPS) foam panel, a polyurethane foam panel (PUR), or a polyisocyanurate (PIR) foam panel, especially having a density of 10-150 g/l, more preferably 15-100 g/l, even more preferably 25-75 g/l and/or a thickness of 5-500 mm, preferably 10-350 mm, even more preferably 25-150 mm.

In further embodiments, the substrate layer comprises a high-density panel, especially having a density of at least 200 g/l, particularly at least 300 g/l. Such high density panels are especially suitable for use in cover boards.

In embodiments, the high-density panel is selected from the group consisting of a gypsum, fiber-reinforce gypsum, plywood, compressed wood, wood fiber, cementitious, high-density (compressed) polyisocyanurate, perlite, mineral fiber, or an oriented strand panel. These types of panels are durable and provide superior impact and puncture resistance, which is required in cover boards.

In embodiments, the high-density panel has a density of 200-1500 g/l, preferably 300-1250 g/l, more preferably 500-1000 g/l and/or a thickness of 5-250 mm, preferably 10-200 mm, even more preferably 15-150 mm.

In embodiments, the substrate layer further comprises a first facer attached to at least a portion of the upper major surface of the low- or high-density panel and/or a second facer attached to at least a portion of the lower major surface of the low- or high-density panel.

Preferably, the first and/or second facer covers at least 50%, more preferably at least 75%, even more preferably at least 85%, still more preferably at least 95%, of the total area of the upper and/or lower major surface of the low- or high-density panel, respectively.

In embodiments, the outer major surface of the first facer facing away from the low- or high-density panel forms the upper primary exterior surface of the substrate layer and/or the outer major surface of the second facer facing away from the low- or high-density panel forms the lower primary exterior surface of the substrate layer.

Suitable materials for the first and second facers include, for example, metals, such as aluminum foils, cellulosic fibers, reinforced cellulosic fibers, Kraft paper, coated glass fiber mats, uncoated glass fiber mats, chopped glass, and combinations thereof. Further suitable facer materials include fiber board, perlite board, and gypsum board.

Preferred thickness of the facers depends mainly on the material of the facers. Especially, the first and second facers may have a thickness of 0.15-10 mm, particularly 0.25-5 mm, such as 0.35-2.5 mm. In case of more rigid facer material, such as fiber or gypsum board, the thickness can be in the range of 0.5-35 mm, especially 0.65-25 mm.

The preferences given above for the substrate layer, the adhesive layers, the release liners, and the facers apply equally to all subjects of the present invention unless otherwise stated.

Another aspect of the present invention is a method for producing an insulation or cover board of the present invention, the method comprising steps of:
A) Providing a substrate layer (2),
B) Applying a non-reactive hot-melt pressure sensitive adhesive as a melt to one of the primary exterior surfaces of the substrate layer (2),
C) Letting the applied adhesive layer to cool and to solidify, and
D) Optionally covering at least a portion of the outer major surface of the adhesive layer (3) facing away from the substrate layer (2) with a release liner (4).

In step B) of the method, the non-reactive hot-melt pressure sensitive adhesive is heated to a temperature above the softening point and/or melting point of the adhesive and applied to a surface of the substrate layer in molten state using any conventional techniques, for example, slot die coating, extrusion coating, roller coating, direct gravure coating, offset gravure coating, reverse gravure roll-coating, powder dispersion, or spray lamination techniques.

In embodiments, the non-reactive hot-melt pressure sensitive adhesive has a viscosity at 120° C. of 250-25000 mPa*s, preferably 500-20000 mPa*s and/or a softening point measured with Ring & Ball method according to ISO 4625-1:2020 standard of 85-165° C., preferably 95-145° C. and/or a melting point determined by differential scanning calorimetry (DSC) according to ISO 11357-3 standard using a heating rate of 2° C./min of 95-175° C., preferably 105-155° C.

The viscosity of the non-reactive hot-melt pressure sensitive adhesive can be measured using a Brookfield viscometer according to EN ISO 2555:2018-09 standard, for example, with spindle 5 at 20 rpm.

In embodiments, the non-reactive hot-melt pressure sensitive adhesive is applied to a primary exterior surface of the substrate layer in a pattern composed of a plurality of spaced-apart adhesive elements, preferably in form of adhesive stripes or dots.

Another aspect of the present invention is a method for providing an insulated structure (5) comprising steps of:
I) Providing an insulation board (1) according to any one of claims 1-11 and
II) Positioning the insulation board (1) on a surface of a substrate (6) and pressing the insulation board (1) against the surface of the substrate (6) with a pressure sufficient to effect adhesive bonding between the insulation board (1) and the substrate (6).

In embodiments, the substrate is selected from a concrete, wood, metal, and a brick substrate.

In embodiments, the substrate is selected from a roof deck, a stud wall, a roof rafter, a roof framing member, a concrete masonry, particularly a concrete masonry wall, a brick masonry, particularly a masonry block wall, metal ductwork, for example an exterior side of a metal ductwork.

In embodiments, the method comprises further steps of:
III) Covering at least a portion of the upper major surface of the insulation board (1) with a roofing membrane (7) or with a cover board (1′) of the present invention and
IV) Pressing the roofing membrane (7) or the cover board (1′) against the surface of the insulation board (1) with a pressure sufficient to effect adhesive bonding between the roofing membrane (7) and the insulation board (1) or between the cover board (1′) and the insulation board (1).

In these embodiments, the substrate is preferably a roof substrate, especially a roof deck, for example a concrete, wood, particularly a plywood, or a metal roof deck.

The term “roof deck” refers in the present disclosure to a structural supporting surface of a building extending between the surrounding exterior walls of the building. A roof deck may be composed, for example, of concrete, plywood, or metal.

In embodiments, the roofing membrane is a self-adhering roofing membrane comprising at least one waterproofing layer and a layer of a pressure sensitive adhesive. In these embodiments, the insulation board provided in step I) of the method preferably comprises an adhesive layer arranged on the lower primary exterior surface of the substrate layer.

Suitable self-adhering roofing membranes are commercially available, for example, from Sika AG under the trade name of Sarnafil® G 410 SA and Sarnafil® TG 76 FSA; from Versico Roofing Systems under the trade name of VersiWeld® QA; and from Carlisle SynTec Systems under the trade name of Sure-Weld® TPO SAT.

In further embodiments, the roofing membrane is a non-self-adhering roofing membrane comprising at least one waterproofing layer. In these embodiments, the insulation board provided in step I) of the method may comprise a first adhesive layer arranged on the lower primary exterior surface of the substrate layer and a second adhesive layer arranged on the upper primary exterior surface of the substrate layer, wherein the roofing membrane is bonded to the upper major surface of the insulation board via the second adhesive layer of the insulation board and the insulation board is bonded to the surface of the roof deck via the first adhesive layer of the insulation board. An insulated structure obtained by using a method according to these embodiments is shown in FIG. 4.

Commonly used materials for the at least one waterproofing layer of the roofing membrane include plastics, particularly thermoplastics such as plasticized polyvinylchloride (p-PVC), thermoplastic olefins (TPE-O, TPO), elastomers such as ethylene-propylene diene monomer (EPDM), and bitumen. The thickness of the at least one waterproofing layer is not particularly restricted, and it depends mainly on the material of the waterproofing layer as well as on the number of waterproofing layers in the roofing membrane. In embodiments, the at least one waterproofing layer has a thickness determined by using the measurement method as defined in EN 1849-2 standard of 0.25-5 mm, preferably 0.5-4.5 mm, more preferably 1-3 mm, most preferably 1-2.5 mm.

In embodiments, at least a portion of the upper major surface of the insulation board is covered with a cover board of the present invention in step III) of the method, wherein the cover board comprises an adhesive layer arranged on the lower primary exterior surface of the substrate layer of the cover board.

In these embodiments, the insulation board provided in step I) of the method preferably comprises an adhesive layer arranged on the lower primary exterior surface of the substrate layer of the insulation board, wherein the cover board is bonded to the upper major surface of the insulation board via the adhesive layer of the cover board and the insulation board is bonded to the surface of the roof substrate via the adhesive layer of the insulation board.

### Examples

### Preparation of a Self-Adhering Insulation Boards

A paper faced polyisocyanurate (PIR) insulation board Atlas® AC II (from Atlas Roofing Corporation) was used for preparing a self-adhering insulation board.

A sample of the insulation board having a size 15 cm×22.5 cm was cut and four beads of hot melt adhesive (Palmetto HM0427 CB) were applied to an area in the center of the board measuring 10 cm×10 cm. Each bead was set about 25.4 mm apart. The beads on the edge of the formation were set back about 12.7 mm from the edge of the 10 cm×10 cm adhesive area. The beads were applied by hand using a piping bag with a 6.4 mm orifice. To apply the beads, a portion of the hot melt adhesive was placed in the piping bag and placed into a 140° C. oven until molten (about 30 minutes), the hot melt was then manually forced out of the orifice onto the insulation board to form the beads.

Immediately after the beads were applied a piece of siliconized paper release liner having a thickness of 54 μm was pressed onto the adhesive. The adhesive was then allowed to cool to room temperature. After the application of the release liner each bead was about 14 mm wide and 1.5 mm thick. The average coating weight of the adhesive was about 0.7 mg/mm².

### Vertical Pull Test

The release liner was peeled away, and a 10 cm×10 cm piece of plywood substrate board was pressed onto the adhesive coated region of the sample PIR insulation board to effect adhesive bonding between the substrate board and the insulation board. The sample was left to rest at room temperature for 24 hours. The insulation board was clamped into a tensile tester (Instron model 3345) as the base. A vertical pull test using a pulling speed of 1.25 cm/min was performed.

A vertical pull resistance of 0.027 N/mm² (578 psf) was obtained with the plywood substrate (average of 3 samples). The measured values of the pull resistance clearly exceed the minimum requirement of 60 psf according to FM 4450, Approval Standard for Class 1 Insulated Steel Roof Decks.

1. An insulation or cover board comprising:
i. a substrate layer having upper and lower primary exterior surfaces,
ii. an adhesive layer covering at least a portion of one of the primary exterior surfaces of the substrate layer, and
iii. optionally a release liner,
wherein the adhesive layer is formed of a non-reactive hot-melt pressure sensitive adhesive.

2. The board according to claim 1, wherein the adhesive layer has a softening point measured with Ring & Ball method according to ISO 4625-1:2020 standard of 85-165° C., and/or a melting point determined by differential scanning calorimetry according to ISO 11357-3 standard using a heating rate of 2° C./min of 95-175.

3. The board according to claim 1, wherein the adhesive layer comprises at least one polymer P selected from styrene block copolymers, acrylic polymers, thermoplastic polyolefins, ethylene vinyl acetate copolymers, and rubbers.

4. The board according to claim 1 wherein the adhesive layer covers not more than 75% of the total area of the upper or lower primary exterior surface of the substrate layer and/or wherein the adhesive layer has a coating weight of 50-1500 g/m².

5. The board according to claim 1, wherein the adhesive layer is a discontinuous layer.

6. The board according to claim 5, wherein the spaced-apart adhesive elements are in form of adhesive stripes.

7. The board according to claim 5, wherein the adhesive stripes have a width of 1.0-20 mm and/or the distance between two adjacent adhesive stripes is at least 15 mm.

8. The board according to claim 1, wherein the substrate layer comprises a low-density panel.

9. The board according to claim 8, wherein the low-density foam panel is a molded expanded polystyrene foam panel, an extruded expanded polystyrene foam panel, a polyurethane foam panel, or a polyisocyanurate foam panel.

10. The board according to claim 1, wherein the substrate layer comprises a high-density panel selected from the group consisting of a gypsum, fiber-reinforce gypsum, plywood, compressed wood, wood fiber, cementitious, high-density polyisocyanurate, perlite, mineral fiber, or an oriented strand panel.

11. The board according to claim 8, wherein the substrate layer further comprises a first facer attached to at least a portion of the upper major surface of the low- or high-density panel and/or a second facer attached to at least a portion of the lower major surface of the low- or high-density panel.

12. A method for producing an insulation or cover board according to claim 1, the method comprising steps of:
A) Providing a substrate layer, layer,
B) Applying a non-reactive hot-melt pressure sensitive adhesive as a melt to one of the primary exterior surfaces of the substrate layer,
C) Letting the applied adhesive layer to cool and to solidify, and
D) Optionally covering at least a portion of the outer major surface of the adhesive layer facing away from the substrate layer with a release liner.

13. The method according to claim 12, wherein the non-reactive hot-melt pressure sensitive adhesive has a viscosity at 160° C. measured using a Brookfield viscometer according to EN ISO 2555:2018-09 standard of 250-25000 mPas and/or a softening point measured with Ring & Ball method according to ISO 4625-1:2020 standard of 85-165° C. and/or a melting point determined by differential scanning calorimetry according to ISO 11357-3 standard using a heating rate of 2° C./min of 95-175° C.

14. The method according to claim 12, wherein the non-reactive hot-melt pressure sensitive adhesive is applied to the primary exterior surface of the substrate layer in a pattern composed of a plurality of spaced-apart adhesive elements.

15. A method for providing an insulated structure comprising steps of:
I) Providing an insulation board according to claim 1 and
II) Positioning the insulation board (Hon a surface of a substrate and pressing the insulation board against the surface of the substrate with a pressure sufficient to effect adhesive bonding between the insulation board and the substrate.

16. The method according to claim 15, wherein the substrate is selected from a concrete, wood, metal, and a brick substrate.

17. The method according to claim 15, wherein the substrate is selected from a roof deck, a stud wall, a roof rafter, a roof framing member, a concrete masonry, a brick masonry, ductwork.

18. The method according to claim 15 comprising further steps of:
III) Covering at least a portion of the upper major surface of the insulation board with a roofing membrane or with a cover board and
IV) Pressing the roofing membrane or the cover board against the surface of the insulation board with a pressure sufficient to effect adhesive bonding between the roofing membrane and the insulation board or between the cover board and the insulation board.
